(19) United States
(12) Patent Application Publication
(10) Pub. No.: US 2018/0343809 A1
(43) Pub. Date: Dec. 6, 2018

(54) Zippered Transplant Grow Pot

(71) Applicant: Jenna Sherman, Golden, CO (US)

(72) Inventor: Jenna Sherman, Golden, CO (US)

(21) Appl. No.: 15/609,921

(22) Filed: May 31, 2017

(51) Int. Cl. A01G 9/10; A01G 9/02

(52) U.S. Cl. CPC A01G 9/10; A01G 2009/003; A01G 9/026

(57) ABSTRACT

A zippered transplant grow pot used for transplanting consists of a lateral wall, at least two slits, a base section, an opening, at least two zippers, and at least two flaps. The lateral wall and the base section construct the planting pot body that is used to hold the plant and soil surrounding the roots of the plant. The opening is used to place the plant within the area designated by the lateral wall and the base section. When the transplanting process is to be executed, the user widens the slit with the use of the zipper. By doing so, the hold on the root ball is removed so that the plant and soil surrounding the roots can be removed without damaging the roots of the plant. The flap is used to prevent the roots from growing into the zipper.

### FIELD OF THE INVENTION

The present invention relates generally to plant growing pots. More specifically, the present invention introduces a zippered transplant growing pot that can be used in transplanting and other comparable processes.

### BACKGROUND OF THE INVENTION

In agriculture and gardening, transplanting or replanting is the technique of moving a plant from one location to another. Even though existing transplanting techniques are effective, there are some notable drawbacks.

In conventional transplanting, when the plant needs to be removed from the growing pot, the plant is either moved around or the cloth pot holding the plant is ripped open. By moving the plant within the cloth pot, the roots of the plant can be damaged and the overall health of the plant can be affected. Therefore, the need for a method that can protect the roots during the transplant process is clear.

If the cloth pot holding the plant is ripped during the transplanting process, the cloth pot needs to be discarded afterwards. When transplanting is done at a large scale for a considerable time, continuously discarding cloth pots can be financially disadvantageous to the user. Therefore, a method for preserving the cloth pot for reuse after transplanting is required.

The time required to execute the transplanting process and the labor required are some of the other disadvantages of conventional transplanting methods. To maximize profits and increase efficiency, the time and labor required needs to be minimized.

The objective of the present invention is to address the aforementioned issues. More specifically, the present invention is a zippered transplant grow pot that can be used to increase the efficiency of transplanting and maximize profits. The present invention is reusable, and thus, is financially beneficial to the user. Moreover, the present invention is designed to protect the roots of the plant during the transplanting process. Thus, the overall health of the plant is not affected.

### BRIEF DESCRIPTION OF THE DRAWINGS

FIG. 1 is a perspective view of the present invention.

FIG. 2 is another perspective view of the present invention.

FIG. 3 is a front view of the present invention.

FIG. 4 is a side view of the present invention, wherein the lateral wall is separated at a corresponding slit of the at least two slits.

FIG. 5 is a perspective view of the present invention, wherein the lateral wall is separated at a corresponding slit of the at least two slits.

### DETAIL DESCRIPTIONS OF THE INVENTION

All illustrations of the drawings are for the purpose of describing selected versions of the present invention and are not intended to limit the scope of the present invention.

The present invention, which is intended to be used in transplanting, increases transplanting efficiency and maximizes profits. To do so, the present invention is designed to address many drawbacks prevalent with conventional transplanting methods. Issues such as root damage and planting pot damage are addressed by the present invention.

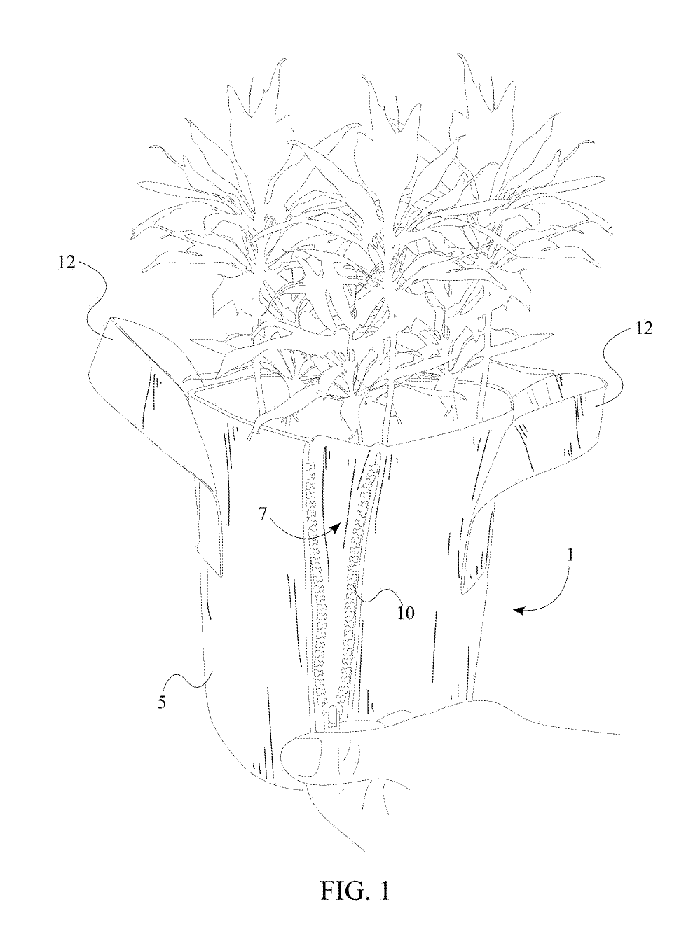

As illustrated in FIGS. 1-3, the present invention comprises a lateral wall 1, at least two slits 7, a base section 8, an opening 9, at least two zippers 10, and at least two flaps 11. The lateral wall 1 along with the base section 8 forms the planting pot body of the present invention. When the planting pot body is formed, the plant and soil surrounding the root of the plant is placed within the planting pot body via the opening 9. The size of the opening 9 can vary from one embodiment to another. Similarly, the size and shape of the lateral wall 1 can also vary according to the plant that is being used with the present invention. As an example, if the present invention is available in sizes such as 1-gallon size, a 5-gallon size, or a 10-gallon size, the opening 9 and the lateral wall 1 will vary accordingly. The main purpose of the lateral wall 1 is to hold the soil around the root of the plant. Along with the lateral wall 1, the base section 8 also aids in holding the soil around the root. The base section 8 holds the weight of the soil. Therefore, a sewing reinforcement can be used along with the base section 8. The hold on the root is adjusted with the use of the at least two slits 7. To do so, the at least two zippers 10 and the at least two flaps 11 are used in conjunction with the at least two slits 7. The at least two slits 7, the at least two flaps 11, and the at least two zippers 10 allows the lateral wall 1 to be folded or rolled so that the plant can be conveniently removed for transplanting.

In order to hold the soil around the root of the plant, the lateral wall 1 comprises a first end 2, an inner surface 4, a body 5, an outer surface 6, and a second end 3. The first end 2 and the second end 3 are positioned opposite to each other along the body 5 and determines the overall height of the lateral wall 1. The body 5, which is positioned in between the inner surface 4 and the outer surface 6, determines the overall thickness of the lateral wall 1. To maintain the wellbeing of the plant the present invention is being used with, the body 5 is made of a breathable material. Moreover, the body 5 can made of a material that is stretchable so that the body 5 can stretch during a transplanting process.

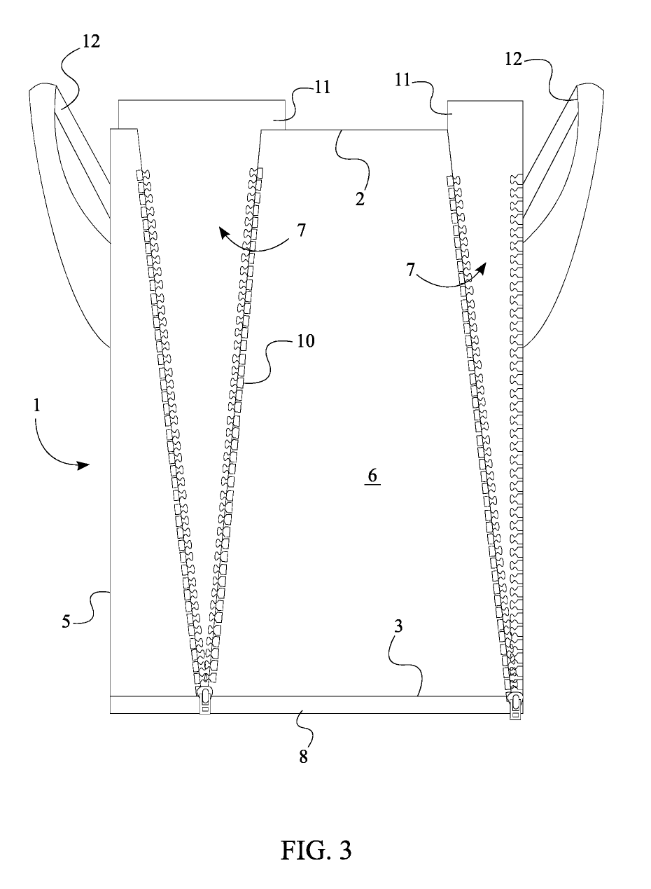

As shown in FIG. 3, the lateral wall 1 is connected to the base section 8 at the second end 3. More specifically, the base section 8 is perimetrically connected to the body 5 at the second end 3. As mentioned before, the first end 2 and the second end 3 are positioned opposite to each other along the body 5. The opening 9, which is used for placing and removing the plant, is positioned at the first end 2 opposite to the base section 8.

As mentioned before, the at least two slits 7 are used for adjusting the overall hold on the soil surrounding the roots of the plant. More specifically, the at least two slits 7 determines the overall hold maintained by the lateral wall 1 on the root ball of the plant. To do so, the at least two slits 7 traverse into the body 5 through the outer surface 6 and the inner surface 4. The size of the at least two slits 7 can vary in different embodiments of the present invention. In the preferred embodiment of the present invention, the at least two slits 7 are perpendicular to the base section 8 and extend from the first end 2 to the second end 3. More specifically, the slits 7 extend from the opening 9 to the base section 8. Thus, the hold on the root ball of the plant can be adjusted with the at least two slits 7.

The at least two zippers 10 are used to control the at least two slits 7. To do so, a corresponding zipper from the at least two zippers 10 is operatively integrated with the outer surface 6 along a corresponding slit from the at least two slits 7. When in use, there is a probability for the roots of the plant to grow into the at least two zippers 10 through the at least two slits 7. The at least two flaps 11 are used to prevent such issues. More specifically, to prevent the roots from growing into the at least two zippers 10, a corresponding flap from the at least two flaps 11 is connected to the inner surface 4 along the corresponding slit. Thus, the corresponding flap is positioned adjacent the corresponding zipper and prevents the roots from growing into the corresponding zipper. The positioning of the at least two slits 7, the at least two zippers 10, and the at least two flaps 11 can vary from one embodiment to another.

For handling purposes, the present invention further comprises at least one handle 12 that is connected to the outer surface 6. If the plant used with the present invention needs to be moved, the user can grasp the at least one handle 12 to move the plant from one place to another.

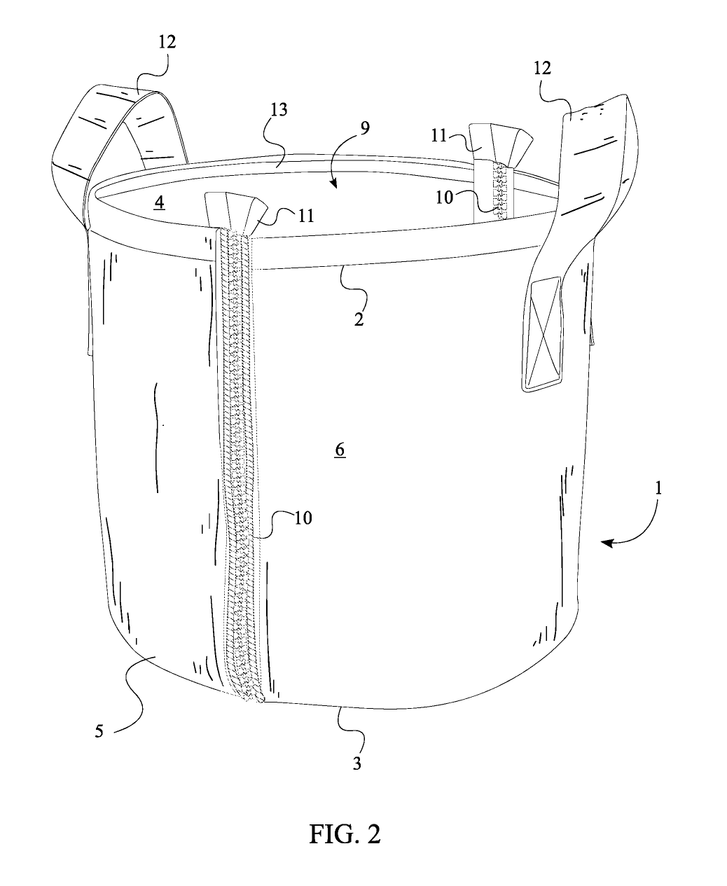

For ornamental purposes, the present invention can further comprise an outer rim 13 which is connected along the first end 2 as shown in FIG. 2. When the outer rim 13 is available, the opening 9 is delineated by the outer rim 13. In addition to the ornamental purposes, the outer rim 13 also provides rigidity to the lateral wall 1.

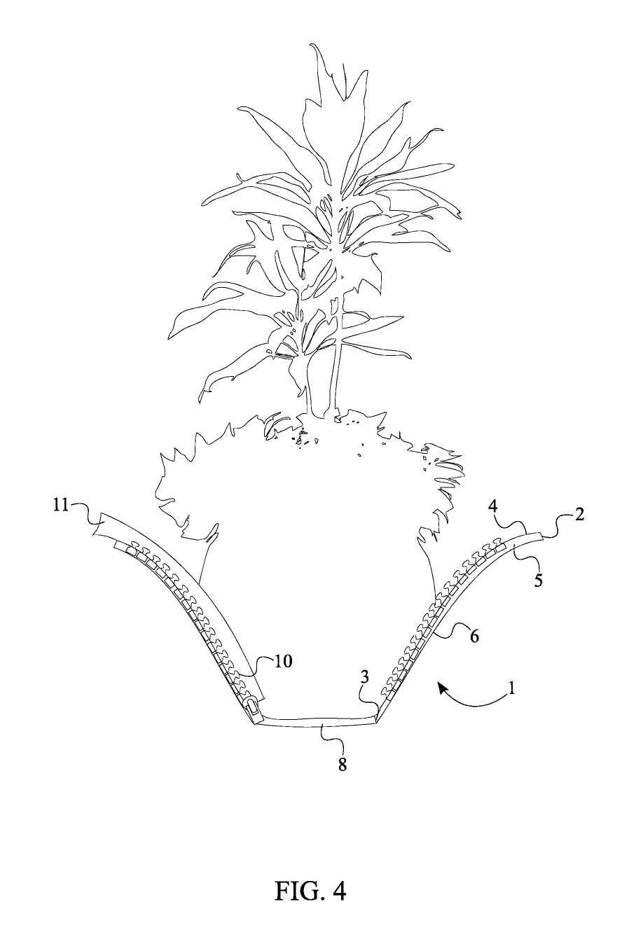

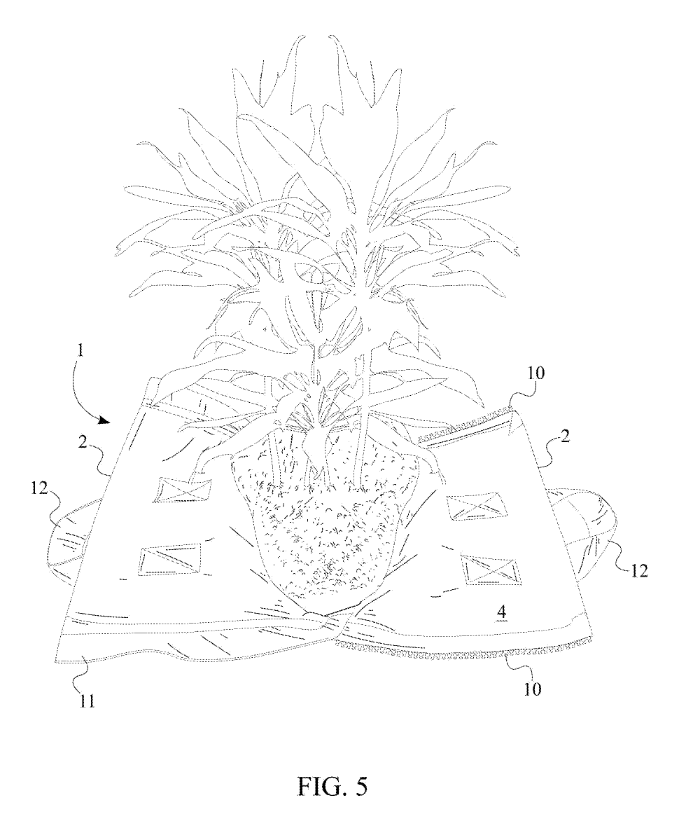

When utilizing the present invention, the following process flow is generally followed. Initially, the at least two zippers 10 are used to close the at least two slits 7. Then, the plant and soil is placed in the area determined by the lateral wall 1 and the base section 8. More specifically, the root ball of the plant is positioned on the base section 8. If the plant needs to be transported, the user grasps the at least one handle 12. When the plant is at the preferred position and the user is about to execute the transplanting process, the at least two zippers 10 are used to expand the at least two slits 7 as shown in FIG. 4. By doing so, the user can proceed to separate the lateral wall 1 from the plant as illustrated in FIG. 5. More specifically, the user can roll down the lateral wall 1 to the base section 8 so that the plant can be removed and used for transplanting. Since the roots of the plant are not damaged, a successful transplanting process can be executed with the use of the present invention.

Although the invention has been explained in relation to its preferred embodiment, it is to be understood that many other possible modifications and variations can be made without departing from the spirit and scope of the invention as hereinafter claimed.

What is claimed is:

1. A zippered transplant grow pot comprises:
a lateral wall;
at least two slits;
a base section;
an opening;
at least two zippers;
at least two flaps;
the lateral wall comprises a first end, an inner surface, a body, an outer surface, and a second end;
the first end and the second end being positioned opposite to each other along the body;
the body being positioned in between the inner surface and the outer surface;
the base section being perimetrically connected to the body at the second end;
the opening being positioned at the first end opposite to the base section;
the at least two slits traversing into the body through the outer surface and the inner surface and extending from the first end to the second end;
a corresponding zipper from the at least two zippers being operatively integrated with the outer surface along a corresponding slit from the at least two slits; and
a corresponding flap from the at least two flaps being connected to the inner surface along the corresponding slit, wherein the corresponding flap is adjacent the corresponding zipper.

2. The zippered transplant grow pot as claimed in claim 1, wherein the body is made of a breathable material.

3. The zippered transplant grow pot as claimed in claim 1, wherein the at least two slits are perpendicular to the base surface and extends from the opening to the base section.

4. The zippered transplant grow pot as claimed in claim 1 further comprises:
at least one handle; and
the at least one handle being connected to the outer surface.

5. The zippered transplant grow pot as claimed in claim 1 further comprises:
an outer rim;
the outer rim being connected along the first end; and
the opening being delineated by the outer rim.
